(19) United States
(12) Patent Application Publication
(10) Pub. No.: US 2025/0330395 A1
(43) Pub. Date: Oct. 23, 2025

(54) SMART SERVICE ANALYZER

(71) Applicant: Rakuten Symphony, Inc., Tokyo (JP)

(72) Inventor: Tasnim AHMED, Tokyo (JP)

(21) Appl. No.: 18/639,970

(22) Filed: Apr. 19, 2024

(51) Int. Cl. H04L 41/5009; H04M 3/22

(52) U.S. Cl. CPC H04L 41/5009; H04M 3/2218

(57) ABSTRACT

A Smart Service Analyzer obtains Call Direct Record (CDR) Data from Probing Devices of a mobile network. The CDR Data is processed at a Key Performance Indicators (KPI) Generator to generate User Level KPIs. The User Level KPIs are provided to a Customer Experience Index (CEI) Estimator. Machine Learning is applied to the User Level KPIs at the CEI Estimator to generate Generalized User Level CEI Estimates. The Generalized User Level CEI Estimates are provided to a Service Quality Index (SQI) Estimator. Machine Learning is applied to the Generalized User Level CEI Estimates at the SQI Estimator to generate Network Level SQI Estimates.

### TECHNICAL FIELD

This description relates to a Smart Service Analyzer, and method of using the same.

### BACKGROUND

Network performance prediction is important for enabling agile capacity planning in mobile networks. Capacity planning for mobile networks presents a challenge for network planners as traffic in mobile networks continues to grow exponentially. In addition to the growing load in mobile networks, network performance dynamically changes. Performance downgrade is expected to occur in response to a lack of investment in additional capacity. Simultaneously, user and application demand for throughput and latency is ever increasing.

A further problem is that the process of adding capacity to mobile networks comes with long cycles. Mobile operators typically need six months to add a 4G or a 5G layer, and two years to build new base stations. Finally, there is pressure to justify capital expenditures. In such circumstances, predictive planning plays an important role. The decision-making process on capacity addition needs to be based on the accurate estimation of future network performance, and what-if evaluations of different scenarios of traffic growth, network performance and capacity expansions.

Predicting user experience in terms of data throughput in Fourth Generation (4G) and Fifth Generation (5G) mobile network, which are based on Orthogonal Frequency Division Multiple Access (OFDMA) techniques, involves consideration of various parameters. For example, spectrum assets of mobile operators are spread over channels in different frequency bands. Channel bandwidth in Long Term Evolution (LTE) systems is 5, 10, 15 or 20 MHz, while in 5G it can be 50-100 MHz in lower frequency bands, and up to 400 MHz on higher frequency bands. LTE and 5G systems have resource grids deployed over channels, where the available spectrum is split into Resource Blocks (RBs). In LTE, Resource Blocks (RBs) have a size of 180 kHz, whereas in 5G the size is flexible with a value between 180 kHz and 1440 kHz, depending on use case/numerology.

User data throughput in such systems is driven by the number of available resource blocks for users and spectral efficiency of the system. The number of available resource blocks that are shared between users depends on various factors, including network density (number of base stations deployed in area of interest), user density (number of users to be served in area of interest) and deployed capacity (number of frequency channels and bandwidths used by base stations on 4G and 5G networks). Spectral efficiency of the system is measured as an achievable throughput per RB.

Network planners are thus called on to estimate the performance of different services, such as Voice Call, Video Applications, Gaming Applications, Streaming, Roaming, etc., at the user and the network level. Performance patterns change depending on various factors, such as spectrum assets, network grid-topology and density, quality of radio design and implemented radio solutions, network maturity, user distribution and traffic mix, etc. Mobile communication systems provide a very advanced performance measurement capability. Measurements cover different events in the network and various metrics are available. For example, probing devices in the network infrastructure collect Call Direct Record (CDR) data by monitoring, recording, and analyzing network activity at the subscriber level. The performances are estimated as Numerical Index or Ratio (0˜100%). The User Level Index is referred to as Customer Experience Index (CEI) and the Network Level Index is referred to as Service Quality Index (SQI). Key Performance Indictors (KPIs) are applied to CDR data. However, difficulty lies in the ability to process the large volume of CDR data, as well as the transformation of such a large volume of data into actionable intelligence.

### SUMMARY

In at least embodiment, a method includes obtaining Call Direct Record (CDR) Data from Probing Devices of a mobile network. The CDR Data is processed at a Key Performance Indicators (KPI) Generator to generate User Level KPIs. The User Level KPIs are provided to a Customer Experience Index (CEI) Estimator. Machine Learning is applied to the User Level KPIs at the CEI Estimator to generate Generalized User Level CEI Estimates. The Generalized User Level CEI Estimates are provided to a Service Quality Index (SQI) Estimator. Machine Learning is applied to the Generalized User Level CEI Estimates at the SQI Estimator to generate Network Level SQI Estimates.

In at least one embodiment, a Smart Service Analyzer is configured to obtain Call Direct Record (CDR) Data from Probing Devices of a mobile network. The CDR Data is processed at a Key Performance Indicators (KPI) Generator to generate User Level KPIs. The User Level KPIs are provided to a Customer Experience Index (CEI) Estimator. Machine Learning is applied to the User Level KPIs at the CEI Estimator to generate Generalized User Level CEI Estimates. The Generalized User Level CEI Estimates are provided to a Service Quality Index (SQI) Estimator. Machine Learning is applied to the Generalized User Level CEI Estimates at the SQI Estimator to generate Network Level SQI Estimates.

In at least one embodiment, a non-transitory computer-readable media having computer-readable instructions stored thereon, which when executed perform operations including obtaining Call Direct Record (CDR) Data from Probing Devices of a mobile network. The CDR Data are processed at a Key Performance Indicators (KPI) Generator to generate User Level KPIs. The User Level KPIs are provided to a Customer Experience Index (CEI) Estimator. Machine Learning is applied to the User Level KPIs at the CEI Estimator to generate Generalized User Level CEI Estimates. The Generalized User Level CEI Estimates are provided to a Service Quality Index (SQI) Estimator. Machine Learning is applied to the Generalized User Level CEI Estimates at the SQI Estimator to generate Network Level SQI Estimates.

### BRIEF DESCRIPTION OF THE DRAWINGS

Features, aspects, and advantages of certain exemplary embodiments of the disclosure will be described below with reference to the accompanying drawings, in which like reference numerals denote like elements, and wherein:

FIG. 1 illustrates a block diagram of a Mobile Network according to at least one embodiment.

FIG. 2 illustrates a mobile network according to at least one embodiment.

FIG. 3 is a block diagram of an Open Radio Access Network (O-RAN) according to at least one embodiment.

FIG. 4 is a functional block diagram of a Smart Service Analyzer according to at least one embodiment.

FIG. 5 is a flowchart of a method for providing a Smart Service Analyzer according to at least one embodiment.

FIG. 6 is a high-level functional block diagram of a processor-based system according to at least one embodiment.

### DETAILED DESCRIPTION

The following detailed description of example embodiments refers to the accompanying drawings. The foregoing disclosure provides illustration and description, but is not intended to be exhaustive or to limit the implementations to the precise form disclosed. Modifications and variations are possible in light of the above disclosure or may be acquired from practice of the implementations. Further, one or more features or components of one embodiment may be incorporated into or combined with another embodiment (or one or more features of another embodiment). Additionally, in the flowcharts and descriptions of operations provided below, it is understood that one or more operations may be omitted, one or more operations may be added, one or more operations may be performed simultaneously (at least in part), and the order of one or more operations may be switched, as long as these modifications may not affect the resulting scope of the invention.

It will be apparent that systems and/or methods, described herein, may be implemented in different forms of hardware, software, or a combination of hardware and software. The actual specialized control hardware or software code used to implement these systems and/or methods is not limiting of the implementations. Thus, the operation and behavior of the systems and/or methods were described herein without reference to specific software code. It is understood that software and hardware may be designed to implement the systems and/or methods based on the description herein.

Even though particular combinations of features are recited in the claims and/or disclosed in the specification, these combinations are not intended to limit the disclosure of possible implementations. In fact, many of these features may be combined in ways not specifically recited in the claims and/or disclosed in the specification. Although each dependent claim listed below may directly depend on only one claim, the disclosure of possible implementations includes each dependent claim in combination with every other claim in the claim set.

No element, act, or instruction used herein should be construed as critical or essential unless explicitly described as such. Also, as used herein, the articles “a” and “an” are intended to include one or more items, and may be used interchangeably with “one or more.” Where only one item is intended, the term “one” or similar language is used. Also, as used herein, the terms “has,” “have,” “having,” “include,” “including,” or the like are intended to be open-ended terms. Further, the phrase “based on” is intended to mean “based, at least in part, on” unless explicitly stated otherwise. Furthermore, expressions such as “at least one of [A] and [B]”, “[A] and/or [B]”, or “at least one of [A] or [B]” are to be understood as including only A, only B, or both A and B.

Further, spatially relative terms, such as “beneath,” “below,” “lower,” “above,” “upper” and the like, are used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus is otherwise oriented (rotated 90 degrees or at other orientations) and the spatially relative descriptors used herein likewise are interpreted accordingly.

Terms like “user equipment,” “mobile station,” “mobile,” “mobile device,” “subscriber station,” “subscriber equipment,” “access terminal,” “terminal,” “handset,” and similar terminology, refer to a wireless device utilized by a subscriber or user of a wireless communication service to receive or convey data, control, voice, video, sound, gaming, data-streaming or signaling-streaming. The foregoing terms are utilized interchangeably in the subject specification and related drawings. The terms “access point,” “base station,” “Node B,” “evolved Node B (eNode B),” next generation Node B (gNB), enhanced gNB (en-gNB), home Node B (HNB),” “home access point (HAP),” or the like refer to a wireless network component or apparatus that serves and receives data, control, voice, video, sound, gaming, data-streaming or signaling-streaming from UE.

The foregoing disclosure provides illustration and description but is not intended to be exhaustive or to limit the implementations to the precise form disclosed. Modifications and variations are possible in light of the above disclosure or may be acquired from practice of the implementations.

The Smart Service Analyzer is a Machine Learning based architecture that performs sophisticated activity in terms of processing. The Smart Service Analyzer is used to reliably estimate the performance of different services like voice calls, video applications, gaming applications, streaming data, roaming, etc. at the user and the network level. The Smart Service Analyzer determines the performance of those services. The performances are estimated as numerical index or ratio (0-100%). The user level index is referred to as Customer Experience Index (CEI) and the Network Level Index is referred to as Service Quality Index (SQI) for a particular network or a portion of the network. Machine Learning is applied at CEI Estimator and the SQI Estimator using historical user level KPIs. KPIs are parameters of the key performance indicators collected from the Call Direct Record (CDR) data, which comes from the probing devices of the network architecture/network infrastructure. The CEI and SQI estimation is generalized so that the CEI and SQI do not utilize any change or modification after KPIs are added to a service or removed from a service. Data Analytics and Machine Learning (ML) algorithms are applied to automatically estimate the priority of the KPIs in a service. KPI Performance Thresholds are dynamically updated by analyzing trend shifts.

In at least one embodiment, a method includes obtaining Call Direct Record (CDR) Data from Probing Devices of a mobile network. The CDR Data is processed at a Key Performance Indicators (KPI) Generator to generate User Level KPIs. The User Level KPIs are provided to a Customer Experience Index (CEI) Estimator. Machine Learning is applied to the User Level KPIs at the CEI Estimator to generate Generalized User Level CEI Estimates. The Generalized User Level CEI Estimates are provided to a Service Quality Index (SQI) Estimator. Machine Learning is applied to the Generalized User Level CEI Estimates at the SQI Estimator to generate Network Level SQI Estimates.

Embodiments described herein provide method that provides one or more advantages. For example, the Smart Service Analyzer provided an end-to-end automated solution. The Smart Service Analyzer is able to be used as a tool by network engineers to estimate the impact of different services at the user level and at the network level without updating logic and while adding or deleting KPIs from a service. The Smart Service Analyzer notifies stakeholders via automatic email systems while any significant deviation or change is detected in quantitative KPI trends.

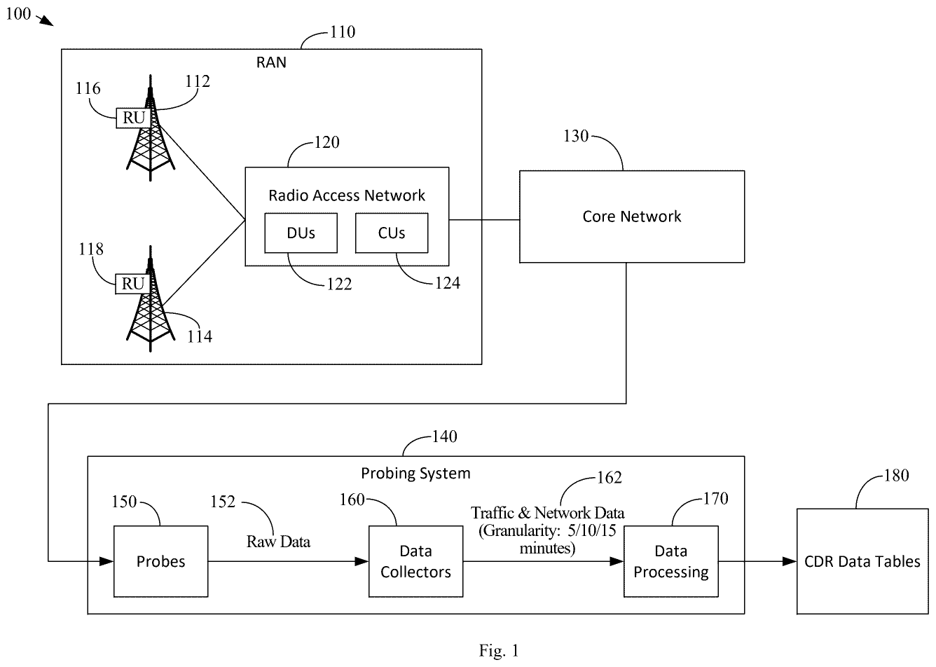

FIG. 1 illustrates a block diagram of a Mobile Network 100 according to at least one embodiment.

In FIG. 1, Mobile Network 100 includes Radio Access Network (RAN) 110. RAN 110 includes eNodeBs 112, 114 for a cell site, which connect to a functional units that form the Radio Network Controller 120. RAN 110 is connected to Core Network 130, which provides access to voice and data networks, such as Internet and Public Switched Telephone Network (PSTN). Disaggregation of RAN 110 involves breaking down of functions into Radio Units (RUs) 116, which are located at the cell tower, Distributed Units (DUs) 122, and Centralized Units (CUs) 124 that form the remainder of the RAN 110. The distribution of the of the RAN across these components is defined by the functional split option that is used. There are various split options for how the RAN functions are split between the RUs 116, 118, DUs 122, and CUs 124.

Mobile Network also includes Probing System 140 for obtaining data about Mobile Network 100. Probing System 140 includes Probes 150. Probes 150 obtain Raw Data 152 that is provide to Data Collectors 160. Data Collectors 160 provide Traffic Network Data 162 to Data Processing 170. Data Processing 170 generates CDR Data Tables 180 based on the Traffic and Network Data 162.

Probes 150 obtains Raw Data 152 from Mobile Network 100 to use as input to a KPI Generator. Probes 150 are devices or software that act as a messenger and converts network communications into an analyzable format. Probes 150 are used to obtain Raw Data 152 about traffic in the Mobile Network 100 that is able to be used to obtain reliable insight into the subscriber experience, and used to analyze the performance and behavior of components of Mobile Network 100 via KPIs. Raw Data 152 is processed into a format, e.g., CDR Data Tables 180, that is able to be used to troubleshoot issues on Mobile Network 100 and to identify root cause of the issue by generating CDR Data Tables 180 per session per subscriber.

CDR Probing Data Tables 180 are able to be provided to a KPI Generator as described below. The CDR Data Tables 180 are provided at a predetermined granularity, e.g., 5 minutes, 10 minutes, 15 minutes, etc. CDR Data Tables 180 include information broken down into different categories. The categories include GI interface, GN interface, Reference Signal Received Power (RSRP), Session Initiation Protocol (SIP), Radio Resource Control (RRC) LTE, S2 Application Protocol (S2AP), Diameter interface, etc. The Probes 150 obtain different types of Raw Data 152 from different types of modules of Mobile Network 100, e.g., DUs 122, CUs 124, etc., which is accumulated by Data Collectors 160. Traffic and Network Data is processed at Data Processing 170 to produce CDR Data Tables 180. Previously, historical probing data was used instead of the User Level KPIs.

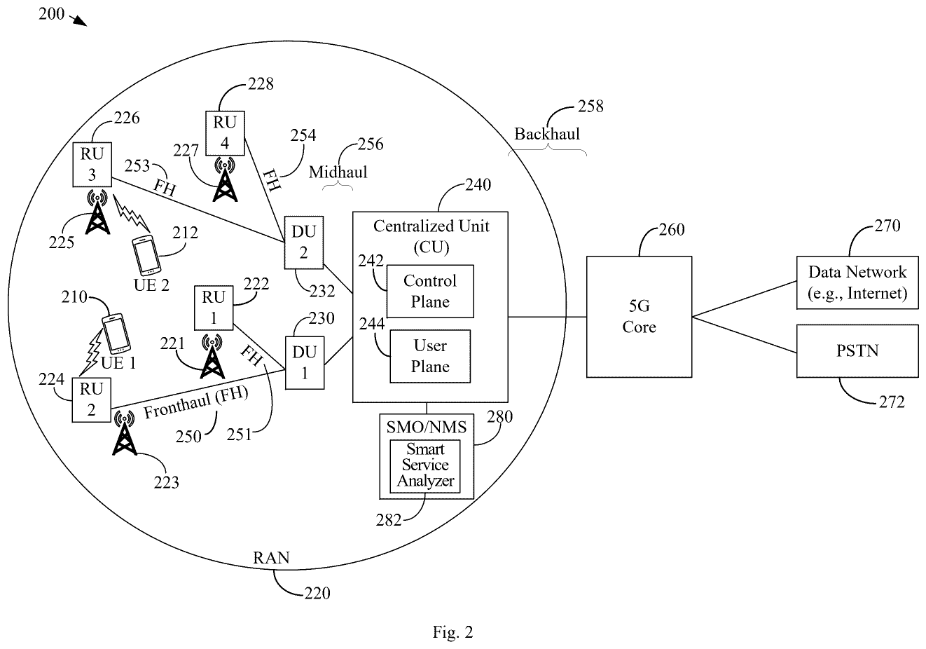

FIG. 2 illustrates a mobile network 200 according to at least one embodiment.

In FIG. 2, UE 2 (User Equipment 2) 210 and UE 2 212 access Mobile Network 200 via a Radio Access Network (RAN) 220. Software functions of RAN 220 are able to be separated from specialized hardware, which is referred to as disaggregation. Disaggregation lead to the virtualization of RAN software, thus enabling RAN functions to be hosted on general-purpose, commercial-off-the-shelf (COTS) hardware. Thus, functions of RAN 220 are able to be split using different split options to implement a Centralized-RAN or Cloud-RAN (C-RAN), Virtualized RAN (V-RAN), an Open-RAN (O-RAN).

RAN 220 includes Radio Towers 221, 223, 225, and 227. Radio Towers 221, 223, 225, 227 are associated with RU (Radio Unit) 2 222, RU 2 224, RU 3 226, and RU 4 228, respectively.

RU 2 222, RU 2 224, RU 3 226, RU 4 228 handle the Digital Front End (DFE) and the parts of the PHY layer, as well as the digital beamforming functionality. RU 2 222 and RU 2 224 are associated with Distributed Unit (DU) 2 230, and RU 3 226 and RU 4 228 are associated with DU 2 232. DU 2 230 and DU 2 232 are responsible for real time Layer 2 and Layer 2 scheduling functions. For example, in 5G, Layer-1 is the Physical Layer, Layer-2 includes the Media Access Control (MAC), Radio link control (RLC), and Packet Data Convergence Protocol (PDCP) layers, and Layer-3 (Network Layer) is the Radio Resource Control (RRC) layer. Layer 2 is the data link or protocol layer that defines how data packets are encoded and decoded, how data is to be transferred between adjacent network nodes. Layer 3 is the network routing layer and defines how data is moves across the physical network.

DU 2 230 is coupled to the RU 2 222 and RU 2 224, and DU 2 232 is coupled to RU 3 226 and RU 4 228. DU 2 230 and DU 2 232 run the RLC, MAC, and parts of the PHY layer. DU 2 230 and DU 2 232 include a subset of the eNB/gNB functions, depending on the functional split option, and operation of DU 2 230 and DU 2 232 are controlled by Centralized Unit (CU) 240. CU 240 is responsible for non-real time, higher L2 and L3. Server and relevant software for CU 240 is able to be hosted at a site or is able to be hosted in an edge cloud (datacenter or central office) depending on transport availability and the interface for the Fronthaul connections 250, 251, 253, 254. The server and relevant software of CU 240 is also able to be co-located at DU 2 230 or DU 2 232, or is able to be hosted in a regional cloud data center.

CU 240 handles the RRC and PDCP layers. The gNB includes CU 240 and one or more DUs, e.g., DU 2 230, connected to CU 240 via Fs-C and Fs-U interfaces for a Control Plane (CP) 242 and User Plane (UP) 244, respectively. CU 240 with multiple DUs, e.g., DU 2 230, and DU 2 232, support multiple gNBs. The split architecture enables a 5G network to utilize different distribution of protocol stacks between CU 240, and DU 2 230 and DU 2 232, depending on network design and availability of the Midhaul 256. While two connections are shown between CU 240 and DU 2 230 and DU 2 232, CU 240 is able to implement additional connections to other DUs. CU 250, in 5G, is able to implement, for example, 256 endpoints or DUs. CU 240 supports the gNB functions such as transfer of user data, mobility control, RAN sharing (MORAN), positioning, session management, etc. However, one or more functions are able to be allocated to the DU. CU 240 controls the operation of DU 230 and DU 232 over the Midhaul interface 256.

Backhaul 258 connects the 4G/5G Core 260 to the CU 240. Core 260 may be, for example, up to 200 km away from the CU 240. Core 260 provides access to voice and data networks, such as Internet 270 and Public Switched Telephone Network (PSTN) 272.

RAN 220 is able to implement beamforming that allows for directional transmission or reception. 5G beamforming enables 5G connections to be more focused toward a receiving device. RAN 220 is also able to implement MIMO (Multiple Input Multiple Output), including mMIMO (massive MIMO), to provide an increases in throughput and signal-to-noise ratio (SNR). MIMO improves the radio link by using the multiple paths over which signals travel from the transmitter to the receiver. The multiple paths are de-correlated and this provides the opportunity to send multiple data streams over them.

Massive MIMO and dense small cell deployments are being implemented to improve radio resource efficiency. However, the intra-cell interference from neighboring cells presents a serious problem. According to at least one embodiment, the modeling of interference patterns in a Massive MIMO deployment is used to identify interfering beams between different sectors so that interference optimization techniques are able to be applied to address interference.

According to at least one embodiment, a northbound platform for the network is provided, such as a Service Management and Orchestration (SMO)/NMS 280. SMO 280 oversees the orchestration aspects, and the management and automation of RAN elements. SMO 280 supports O1, A1 and O2 interfaces. SMO 280 includes Smart Service Analyzer 282, which is a Machine Learning based architecture that performs sophisticated activity in terms of processing. Smart Service Analyzer 282 is used to reliably estimate the performance of different services like voice calls, video applications, gaming applications, streaming data, roaming, etc. at the user and the network level. Smart Service Analyzer 282 determines the performance of those services. The performances are estimated as numerical index or ratio (0-100%). The user level index is referred to as Customer Experience Index (CEI) and the Network Level Index is referred to as Service Quality Index (SQI) for a particular network or a portion of the network.

Smart Service Analyzer 282 applies Machine Learning to generate CEI Estimates and SQI Estimates using user level KPIs. KPIs are parameters of the key performance indicators collected from the Call Direct Record (CDR) data, which comes from the probing devices of the network architecture/network infrastructure. Smart Service Analyzer 282 provides CDR Probing Data obtained from the probing devices to a KPI Generator, where arithmetic operations are run that use multiple columns of the CDR Probing Data and maps columns to apply arithmetic operation. Smart Service Analyzer 282 receives a mapping table from network engineers to map KPIs to columns in tables of the CDR Probing Data.

Smart Service Analyzer 282 also receives arithmetic logic-based Aggregation Formula for KPIs that are used by the KPI Generator to generate KPIs from the CDR Probing data. After running the arithmetic operations, the Smart Service Analyzer 282 provides User Level KPIs to a CEI Estimator. Smart Service Analyzer 282 also receives Service-wise KPI Importance, such as Critical, High, Medium, and Low Indicators, and KPI Performance Thresholds for Qualitative KPIs. Quantitative KPI Performance Thresholds are dynamically updated by analyzing trend deviations.

Based on the Service-Wise Importance, Smart Service Analyzer 282 estimates the priority of the KPIs in a service. Smart Service Analyzer 282 applies Machine Learning at the CEI Estimator to produce estimates of CEI at the service level based on the User Level KPIs. Smart Service Analyzer 282 estimates a KPI weight distribution for the services and aggregates KPI performance per service at the user level. Thus, Smart Service Analyzer 282 generalizes estimates of CEI. Generalizing estimates of CEI results in no change or modification in response to a KPI being added or removed from a particular service. Previously, different types of predefined rule-based algorithms were changed in response to a KPI being removed from some service or added to a service. KPI trend shift events are able to be detected and alarms are automatically emailed to stakeholders.

Smart Service Analyzer 282 provides the User Level KPIs to an Aggregator for aggregation to produce Network Level KPIs. Smart Service Analyzer 282 provides the Network Level KPIs, along with the User Level CEI Estimates as input to SQI Estimator.

Smart Service Analyzer 282 applies Machine Learning at the SQI Estimator to produce Network KPI Weight Distribution and aggregation of User Level CEI Estimates and/or Network Level KPIs per service. Smart Service Analyzer 282 applies the Machine Learning at the SQI Estimator using the Service-wise KPI Importance and KPI Performance Thresholds.

Smart Service Analyzer 282 calculates or estimates Network Level SQI Estimates in two ways. First, Smart Service Analyzer 282 uses the User Level CEI Estimates output from the CEI

Estimator and applies Machine Learning to estimate the Network Level SQI Estimates. Alternatively, Smart Service Analyzer 282 uses the User Level KPIs aggregated at the network level, i.e., Network Level KPIs, and applies Machine Learning to calculate Network SQI Estimates.

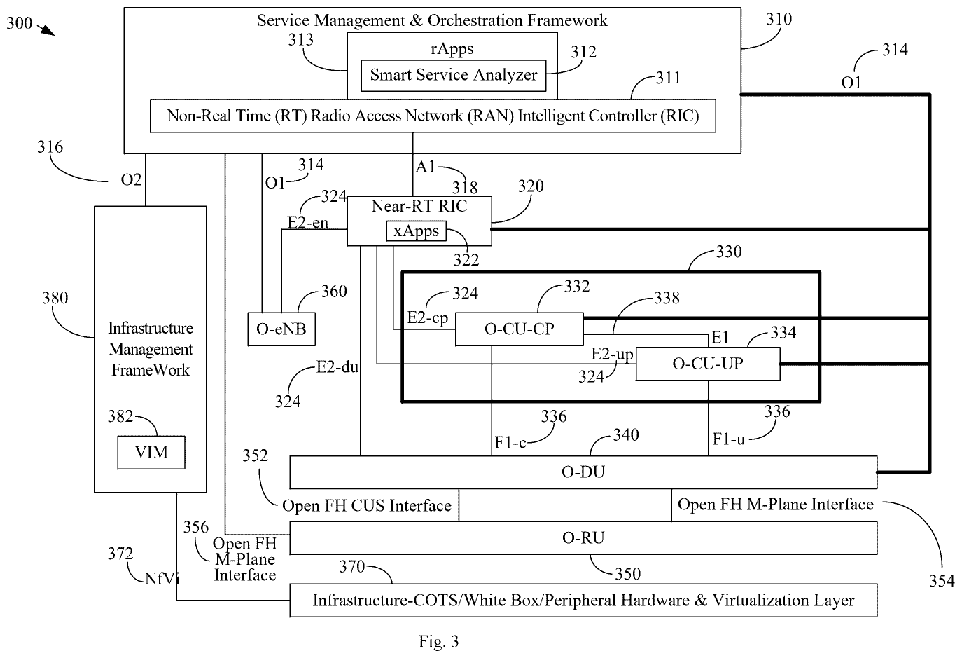

FIG. 3 is a block diagram of an Open Radio Access Network (O-RAN) 300 according to at least one embodiment.

In FIG. 3, Service Management and Orchestration (SMO) Framework 310 is an automation platform for Open RAN Radio Resources. SMO 310 oversees lifecycle management of network functions as well as O-Cloud. SMO 310 includes a Non-Real-Time (RT) Radio Access Network (RAN) Intelligent Controller (RIC) 311. SMO 310 also defines various SMO interfaces, such as the O1 314, O2 316, and A1 318 interfaces.

The A1 interface 318 enables communication between the Non-RT RIC 311 and a Near-RT RIC 320 and supports policy management, data transfer, and machine learning management. The A1 interface 318 is also used for policy guidance. SMO 310 provides fine-grained policy guidance such as getting User-Equipment to change frequency, and other data enrichments to RAN functions over the A1 interface 318.

The O1 314 interface connects the SMO 310 to the RAN managed elements, which include the Near-RT RIC 320, O-RAN Centralized Unit (O-CU) 330, O-RAN Distributed Unit (O-DU) 340, and the Open Evolved NodeB (O-eNB) 360. The management and orchestration functions are received by the managed elements via the O1 interface 314. The SMO 310 in turn receives data from the managed elements via the O1 interface 314 for AI model training at the Non-RT RIC 311. The O1 interface 314 is further used for managing the operation and maintenance (OAM) of multi-vendor Open RAN functions including fault, configuration, accounting, performance and security management, software management, and file management capabilities.

The O2 interface 316 is used to support cloud infrastructure management and deployment operations with O-Cloud infrastructure that hosts the Open RAN functions in the network. The 02 interface 316 supports orchestration of O-Cloud infrastructure resource management (e.g., inventory, monitoring, provisioning, software management and lifecycle management) and deployment of the Open RAN network functions, providing logical services for managing the lifecycle of deployments that use cloud resources.

SMO 310 provides a common data collection platform for management of RAN data as well as mediation for the O1 314, O2 316, and A1 318 interfaces. Licensing, access control and AI/ML lifecycle management are supported by the SMO 310, together with legacy north-bound interfaces. SMO 310 also supports existing OSS functions, such as service orchestration, inventory, topology and policy control.

The Non-RT RIC 311 enables non-real-time (>1 second) control of RAN elements and their resources through cloud-native microservice-based applications, which are referred to as rApps 312. An rApp 312 is able to implement a Smart Service Analyzer 313. Non-RT RIC 311 communicates with applications called xApps 322 running on a Near-RT RIC 311 to provide policy-based guidance for edge control of RAN elements and their resources. The Non-RT RIC 311 provides non-real-time control and optimization of RAN elements and resources, AI/ML workflow, including model training of the Smart Service Analyzer 313, updates, and policy-based guidance of applications/features in Near-RT RIC 320.

Near-RT RIC 320 controls RAN infrastructure at the cloud edge. Near-RT RIC 320 controls RAN elements and their resources with optimization actions that typically take 10 milliseconds to one second to complete. The Near-RT RIC 320 receives policy guidance from the Non-RT RIC 311 and provides policy feedback to the Non-RT RIC 311 through the xApps 322.

The xApps 322 are used to enhance the RAN's spectrum efficiency. The Near-RT RIC 320 manages a distributed collection of “southbound” RAN functions, and also provides “northbound” interfaces for operators: the O1 314 and A1 318 interfaces to the Non-RT RIC 311 for the management and optimization of the RAN. The Near-RT RIC 320 is thus able to self-optimize across different RAN types, like macros, Massive MIMO and small cells, maximizing network resource utilization for 5G network scaling.

Within the Near-RT RIC 320, the xApps 322 communicate via defined interface channels. An internal messaging infrastructure provides the framework to handle conflict mitigation, subscription management, app lifecycle management functions, and security. Data transfers are implemented via the E2 interfaces 324.

The O-RAN is split into a Central Unit (CU) 330, a Distributed Unit (DU) 340, and a Radio Unit (RU) 350. The CU 330 is further split into two logical components, one for the Control Plane (CP) 332, and one for the User Plane (UP) 334. The logical split of the CU 330 into the CP 332 and UP 334 allows different functionalities to be deployed at different locations of the network, as well as on different hardware platforms. For example, CUs 330 and DUs 340 can be virtualized on white box servers at the edge, while the RUs 350 are implemented on Field Programmable Gate Arrays (FPGAs) and Application-specific Integrated Circuits (ASICs) boards and deployed close to RF antennas.

The O-RAN Distributed Unit (O-DU) 340 is an edge server that includes baseband processing and radio frequency (RF) functions. The O-DU 340 hosts radio link control (RLC), MAC, and a physical layer with network function virtualization or containers. O-DU 340 supports one or more cells, and the O-DUs 340 are able to support one or more beams to provide the operating support for O-RU 350 by CUS (Control, User, and Synchronization) planes 352, and management (M) planes 354 through front-haul interfaces.

The O-RU 350 processes radio frequencies received by the physical layer of the network. The processed radio frequencies are sent to the O-DU 340 through fronthaul interfaces 352, 354. The O-RU 350 hosts the lower PHY Layer Baseband Processing and RF Front End (RF FE), and is designed to support multiple 3GPP split options.

An Open-Evolved Node B (O-eNB) 360 provides the hardware aspect of the O-RAN. The management and orchestration functions are received by the managed elements via the O1 interface 314. The SMO 310 in turn receives data from the managed elements via the O1 interface 314 for the Smart Service Analyzer 313 implemented by rApps 312 at Non-RT RIC 311. The O-eNB 360 communicates with the Near-RT RIC 320 via the E2 interface 324. E2 324 enables near-real-time loops through the streaming of telemetry from the RAN and the feedback with control from the Near-RT RIC 320. The E2 interface 324 connects the Near-RT RIC 320 with an E2 node, such as the O-CU-CP 332, O-CU-UP 334, the O-DU 340, and the O-eNB 360. An E2 node is connected to one Near-RT RIC 320, while a Near-RT RIC 320 is able to be connected to multiple E2 nodes. The protocols over the E2 interface 324 are based on the control plane and supports services and functions of Near-RT RIC 320.

An F1 Interface 336 connects the O-CU-CP 332 and the O-CU-UP 334 to the O-DU 340. Thus, the F1 interface 336 is broken into control and user plane subtypes and exchanges data about the frequency resource sharing and other network statuses. One O-CU 330 can communicate with multiple O-DUs 340 via F1 interfaces 336.

An E1 338 interface connects the O-CU-CP 332 and the O-CU-UP 334. The E1 Interface 338 is used to transfer configuration data and capacity information between the O-CU-CP 332 and the O-CU-UP 334. The configuration data ensures the O-CU-CP 332 and the O-CU-UP 334 are able to interoperate. The capacity information is sent from the O-CU-UP 334 to the O-CU-CP 332 and includes the status of the O-CU-UP 334.

The O-DU 340 communicates with the O-RU 350 via an Open Fronthaul (FH) Control, User, and Synchronization (CUS) Plane Interface 352 and an Open Fronthaul (FH) M-Plane (Management Plane) Interface 354. As part of the CUS Plane Interface 352, the C-Plane (control plane) is a frame format that carries data in real-time control messages between the O-DU 340 and O-RU 350 for use to control user data scheduling, beamforming weight selection, numerology selection, etc. Control messages are sent separately for downlink (DL)-related commands and uplink (UL)-related commands.

The U-Plane of the CUS Plane Interface 352 carries the user data messages between the O-DU 340 and O-RU 350, such as the in-phase and quadrature-phase (IQ) sample sequence of the orthogonal frequency division multiplexing (OFDM) signal. The S-plane of the CUS Plane Interface 352 includes synchronization messages used for timing synchronization between O-DU 340 and O-RU 350. The Control and User Plane of the CUS Plane Interface 352 are also used to send information specifying beamforming weights from the O-DU 340 to O-RU 350. Other information includes time resource and frequency resource information.

The Open FH M-Plane 354 connects the O-RU 350 to the O-DU 340, and an optional Open FH M-Plane 356 connects the O-RU 350 to the SMO 310. The O-DU 340 uses the Open FH M-Plane 354 to manage the O-RU 350, while the SMO 310 is able to provide FCAPS (Fault, Configuration, Accounting, Performance, Security) services to the O-RU 350. The Open FH M-plane 354 supports the management features including startup installation, software management, configuration management, performance management, fault management and file management.

The Open FH M-Plane 354 is used by the O-DU 340 to retrieve the capabilities of the O-RU 350 and to send relevant configuration related to the C-Plane and U-Plane (data plane) of the Open FH CUS Interface 352 to the O-RU 350. Together the O1 314 and Open FH M-plane 354 interfaces provide a FCAPS interface with configuration, reconfiguration, registration, security, performance, monitoring aspects exchange with individual nodes, such as O-CU-CP 332, O-CU-UP 334, O-DU 340, and O-RU 350, as well as Non-RT RIC 320.

According to at least one embodiment, AI-Based Network Management is provided at the 5G Edge, such as by a Smart Service Analyzer 313 of rApp 312 at a Non-RT RIC 311.

The Smart Service Analyzer 313 is a Machine Learning based architecture that performs sophisticated activity in terms of processing. The Smart Service Analyzer 313 is used to reliably estimate the performance of different services like voice calls, video applications, gaming applications, streaming data, roaming, etc. at the user and the network level. The Smart Service Analyzer 313 determines the performance of those services. The performances are estimated as numerical index or ratio (0-100%). The user level index is referred to as Customer Experience Index (CEI) and the Network Level Index is referred to as Service Quality Index (SQI) for a particular network or a portion of the network. Machine Learning is applied to generate CEI Estimates and SQI Estimates using historical user level KPIs. KPIs are parameters of the key performance indicators collected from the Call Direct Record (CDR) data, which comes from the probing devices of the network architecture/network infrastructure. The CEI Estimates and SQI Estimates are generalized so that the Smart Service Analyzer 313 does not utilize any change or modification after KPIs are added to a service or removed from a service. Data Analytics and Machine Learning (ML) algorithms are applied by the Smart Service Analyzer 313 to automatically estimate the priority of the KPIs in a service. KPI Performance Thresholds are dynamically updated by analyzing trend shifts.

Infrastructure-COTS/White Box/Peripheral Hardware & Virtualization Layer 370 connects to Infrastructure Management Framework 380 via Network Function Virtualization Interface (NFVI) 372. Virtualized Infrastructure Manager (VIM) 382 at Infrastructure Management Framework 380 controls and manages virtual network functions.

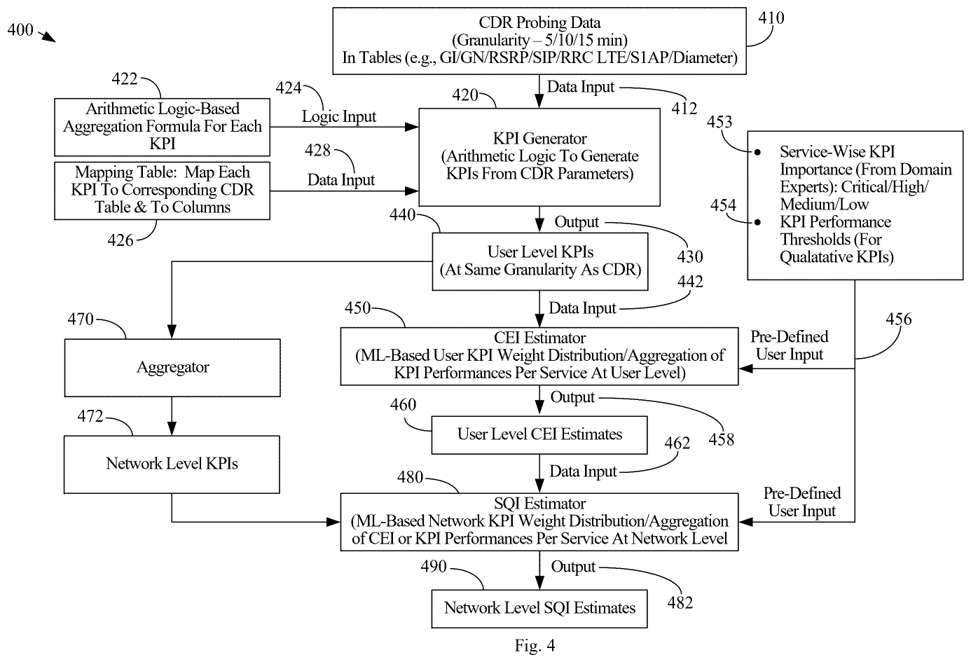

FIG. 4 is a functional block diagram 400 of a Smart Service Analyzer according to at least one embodiment.

In FIG. 4, CDR Probing Data 410 from the probing devices in the network architecture is provided as Input 412 to a KPI Generator 420. A probe is a device or software that acts as a messenger and converts network communications into an analyzable format. Probes are used to analyze network traffic and obtain reliable insight into the subscriber experience, analyze the performance and behavior of network components in a dynamic environment via KPIs, and troubleshoot issues on the network and identify root cause of the issue by generating CDR Probing Data 410 per session per subscriber.

CDR Probing Data 410 is provided to the KPI Generator 420 in tables. The CDR Probing Data 410 is provided at a predetermined granularity, e.g., 5 minutes, 10 minutes, 15 minutes, etc. CDR Probing Data also has different categories. The categories include GI interface, GN interface, Reference Signal Received Power (RSRP), Session Initiation Protocol (SIP), Radio Resource Control (RRC) LTE, S2 Application Protocol (S2AP), Diameter interface, etc. The different types of probing data obtained from different types of network modules are accumulated. Previously, it was users historical probing data was used instead of the User Level KPIs.

As mentioned above, the Customer Experience Index is referred to as Customer Experience Index (CEI) Estimates and the Network Level Index is referred to as Service Quality Index (SQI) Estimates, which are produced using KPIs. KPIs are first calculated from the CDR Probing Data 410. KPI Generator 420 receives an arithmetic logic-based Aggregation Formula 422 for KPIs that are provide as Logic Input 424 to KPI Generator 420. The Aggregation Formulas 422 are also provided by network engineers. Mapping information is provided by Mapping Table 426 that is provided as Data Input 428 to KPI Generator 420. Mapping Table 426 is provided by network engineers. The Mapping Table 424 maps a KPI to a corresponding CDR table and columns in the CDR table of CDR Probing Data 410. KPI Generator 420 runs arithmetic operations that use multiple columns of a table in CDR Probing Data 410 and maps which columns to apply arithmetic operation for which KPI, e.g., which columns in tables of CDR Probing Data 410 to use for which KPI. KPI Generator 420 applies arithmetic logic-based Aggregation Formula 422 for a KPI to generate the KPIs from the CDR Probing Data 410.

After running the arithmetic operations, the KPI Generator 420 produces as Output 430 the User Level KPIs 440. The User Level KPIs 440 is at the same granularity as the CDR Probing Data 410. User Level KPIs 440 are provided as Data Input 442 to CEI Estimator 450. CEI Estimator 450 applies Machine Learning to produce User Level CEI Estimates 460 at the service level based on the User Level KPIs 440. KPIs are divided into two categories: Qualitative KPIs and Quantitative KPIs. Qualitative KPIs are scaled directly between 0 and 100% using pre-defined performance thresholds, such as Success-rate or Failure rate. Quantitative KPIs do not have any Performance Threshold, such as Release Cause Count or Data Traffic Throughput. In general, Quantitative KPIs do not have any qualitative range of values. Instead, Quantitative KPIs rely on what is the current quantity of those KPI values. For example, throughput to a device, success count or failure count of connectivity between two devices, etc. Counts or bandwidth information from throughput information are quantities.

Service-Wise KPI Importance 453, such as Critical, High, Medium, and Low Indicators, and KPI Performance Thresholds 454 for Qualitative KPIs are provided to the CEI Estimator 450 as Pre-Defined User Input 456 to CEI Estimator 450. The Service-Wise KPI Importance 453 is developed by domain experts/network engineers. Network engineers do not provide information regarding KPI weight distribution. However, Network engineers do provide insight on KPI Importance 453. Quantitative KPI Performance Thresholds 454 are able to be dynamically updated by analyzing trend shifts. KPI Performance Thresholds 454 refer to what extent of values represent a good KPI value or a bad KPI value. Sometimes KPI Performance Thresholds 454 are predefined by network engineers, while at other times KPI Performance Thresholds 454 are to be dynamic and are thus based on the trends. Thus, in response to a trend deviating from a band, new KPI Performance Thresholds 454 are created based on the shift of the trend. The dynamically updating of the KPI Performance Thresholds 454 based on trends is also automated. In response to a trend shift, stakeholders are able to be sent automatic emails indicating that the trend has shifted and the thresholds are to be updated. Thus, the stakeholders are able to review this information and confirm the trend shift.

Based on the Service-Wise Importance 453 and the KPI Performance Thresholds 454, CEI Estimator 450 applies Machine Learning to produce as Output 458 User Level CEI Estimates 460.

CEI Estimator 450 automatically estimates the priority of the User Level KPIs 440 in a service. Inside one service there could be several User Level KPIs 440 and which of the several User Level KPIs 440 are the highest priority is automatically estimated using Machine Learning.

CEI Estimator 450 applies Machine Learning to estimate KPI Weight Distribution for the services. The CEI Estimator 450 aggregates KPI performance per service at the user level. Thus, CEI Estimator 450 generalizes User Level CEI Estimates 460. Generalizing User Level CEI Estimates 460 results in no change or modification in response to a KPI being added or removed from a particular service. Previously, different types of predefined rule-based algorithms were changed in response to a KPI being removed from some service or added to a service. KPI trend shift events are able to be detected and alarms are automatically emailed to stakeholders.

User Level CEI Estimates 460 from CEI Estimator 450 are provided as Input 462 to SQI Estimator 480. User Level KPIs 440 are provided to an Aggregator 470 for aggregation to produce Network Level KPIs 472. Once the User Level KPIs are aggregated by Aggregator 470 at the network level to produce Network Level KPIs 472, the Network Level KPIs 472 are also provided to SQI Estimator 480.

Similar to the CEI Estimator 450, SQI Estimator 480 applies Machine Learning to the Network Level KPIs 472 and the User Level CEI Estimates 460 to produce Network Level SQI Estimates 490 at Output 482 of SQI Estimator 480.

SQI Estimator 480 produces Network Level SQI Estimates 490 that include Network KPI Weight Distribution and aggregation of User Level CEI Estimates 460 and/or Network Level KPIs 472 per service. Again, Pre-Defined User Input 456 is forwarded to the SQI Estimator 480 from the domain expert regarding the Service-Wise KPI Importance 453 and KPI Performance Thresholds 454.

SQI Estimator 480 calculates or estimates Network Level SQI Estimates 490 in two ways. First, SQI Estimator 480 uses the Data Input 462 of User Level CEI Estimates 460 from the CEI Estimator 460 and applies Machine Learning to estimate the Network Level SQI Estimates 490. Alternatively, SQI Estimator 480 uses the User Level KPIs aggregated at the network level to produce the Network Level KPIs 472 and applies Machine Learning to calculate Network SQI Estimates 490.

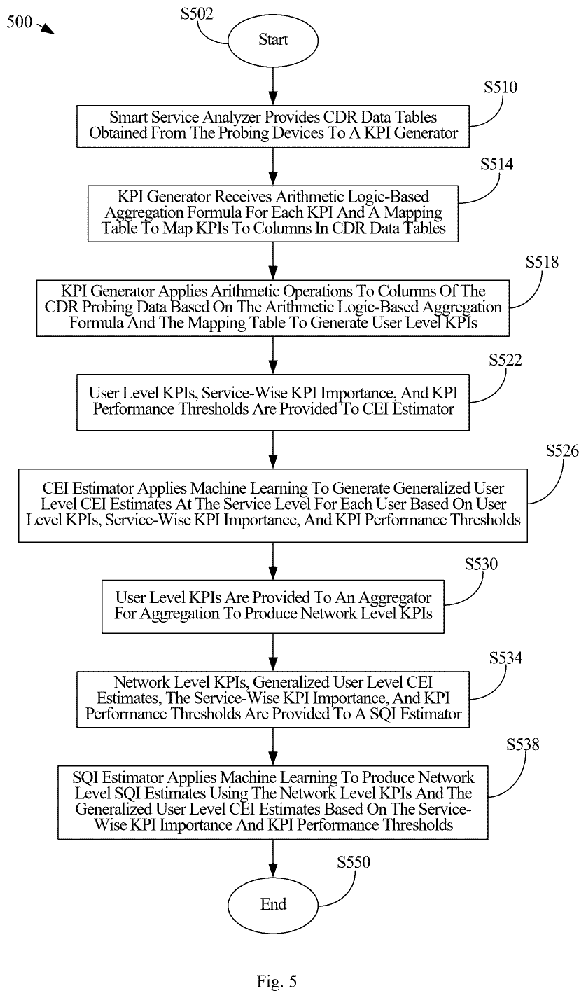

FIG. 5 is a flowchart 500 of a method for providing a Smart Service Analyzer according to at least one embodiment.

In FIG. 5, the process starts S502 and Smart Service Analyzer provides CDR Data Tables obtained from the Probing Devices to a KPI Generator S510. Referring to FIG. 4, CDR Probing Data 410 from the probing devices in the network architecture is provided as Input 412 to a KPI Generator 420. A probe is a device or software that acts as a messenger and converts network communications into an analyzable format. Probes are used to analyze network traffic and obtain reliable insight into the subscriber experience, analyze the performance and behavior of network components in a dynamic environment via KPIs, and troubleshoot issues on the network and identify root cause of the issue by generating CDR Probing Data 410 per session per subscriber. CDR Probing Data 410 is provided to the KPI Generator 420 in tables. The CDR Probing Data 410 is provided at a predetermined granularity, e.g., 5 minutes, 10 minutes, 15 minutes, etc. CDR Probing Data also has different categories. The categories include GI interface, GN interface, Reference Signal Received Power (RSRP), Session Initiation Protocol (SIP), Radio Resource Control (RRC) LTE, S2 Application Protocol (S2AP), Diameter interface, etc. The different types of probing data obtained from different types of network modules are accumulated. Previously, it was users historical probing data was used instead of the User Level KPIs.

KPI Generator receives Arithmetic Logic-Based Aggregation Formula for KPIs and a Mapping Table to map KPIs to columns in CDR Data Tables S514. Referring to FIG. 4, KPI Generator 420 receives an arithmetic logic-based Aggregation Formula 422 for KPIs that are provided as Logic Input 424 to KPI Generator 420. The Aggregation Formulas 422 are also provided by network engineers. Mapping information is provided by Mapping Table 426 that is provided as Data Input 428 to KPI Generator 420. Mapping Table 426 is provided by network engineers. The Mapping Table 424 maps a KPI to a corresponding CDR table and columns in the CDR table of CDR Probing Data 410.

KPI Generator applies Arithmetic Operations to columns of the CDR Probing Data based on the Arithmetic Logic-Based Aggregation Formula and the Mapping Table to generate User Level KPIs S518. Referring to FIG. 4, KPI Generator 420 runs arithmetic operations that uses multiple columns of a table in CDR Probing Data 410 and maps which columns to apply arithmetic operation for which KPI, e.g., which columns in tables of CDR Probing Data 410 to use for which KPI. KPI Generator 420 applies arithmetic logic-based Aggregation Formula 422 for KPIs to generate the KPIs from the CDR Probing Data 410.

User Level KPIs, Service-Wise KPI Importance, and KPI Performance Thresholds are provided to Customer Experience Index (CEI) Estimator S522. Referring to FIG. 4, Service-Wise KPI Importance 453, such as Critical, High, Medium, and Low Indicators, and KPI Performance Thresholds 454 for Qualitative KPIs are provided to the CEI Estimator 450 as Pre-Defined User Input 456 to CEI Estimator 450. The Service-Wise KPI Importance 453 is developed by domain experts/network engineers. Network engineers do not provide information regarding KPI weight distribution. However, Network engineers do provide insight on KPI Importance 453. Quantitative KPI Performance Thresholds 454 are able to be dynamically updated by analyzing trend shifts. KPI Performance Thresholds 454 refer to what extent of values represent a good KPI value or a bad KPI value. Sometimes KPI Performance Thresholds 454 are predefined by network engineers, while at other times KPI Performance Thresholds 454 are to be dynamic and are thus based on the trends. Thus, in response to a trend deviating from a band, new KPI Performance Thresholds 454 are created based on the shift of the trend. The dynamically updating of the KPI Performance Thresholds 454 based on trends is also automated. In response to a trend shift, stakeholders are able to be sent automatic emails indicating that the trend has shifted and the thresholds are to be updated. Thus, the stakeholders are able to review this information and confirm the trend shift.

CEI Estimator applies Machine Learning to generate Generalized User Level CEI Estimates at the service level based on User Level KPIs, Service-Wise KPI Importance, and KPI Performance Thresholds S526. Referring to FIG. 4, Based on the Service-Wise Importance 453 and the KPI Performance Thresholds 454, CEI Estimator 450 applies Machine Learning to produce as Output 458 User Level CEI Estimates 460. CEI Estimator 450 automatically estimates the priority of the User Level KPIs 440 in a service. Inside one service there could be several User Level KPIs 440 and which of the several User Level KPIs 440 are the highest priority is automatically estimated using Machine Learning. CEI Estimator 450 applies Machine Learning to estimate KPI Weight Distribution for the services. The CEI Estimator 450 aggregates KPI performance per service at the user level. Thus, CEI Estimator 450 generalizes User Level CEI Estimates 460. Generalizing User Level CEI Estimates 460 results in no change or modification in response to a KPI being added or removed from a particular service.

User Level KPIs are provided to an Aggregator for aggregation to produce Network Level KPIs S530. Referring to FIG. 4, User Level CEI Estimates 460 from CEI Estimator 450 are provided as Input 462 to SQI Estimator 480. User Level KPIs 440 are provided to an Aggregator 470 for aggregation to produce Network Level KPIs 472. Once the User Level KPIs are aggregated by Aggregator 470 at the network level to produce Network Level KPIs 472, the Network Level KPIs 472 are also provided to SQI Estimator 480.

Network Level KPIs, Generalized User Level CEI Estimates, the Service-Wise KPI Importance, and the KPI Performance Thresholds are provided to a Service Quality Index (SQI) Estimator S534. Referring to FIG. 4, User Level CEI Estimates 460 from CEI Estimator 450 are provided as Input 462 to SQI Estimator 480. User Level KPIs 440 are provided to an Aggregator 470 for aggregation to produce Network Level KPIs 472. Once the User Level KPIs are aggregated by Aggregator 470 at the network level to produce Network Level KPIs 472, the Network Level KPIs 472 are also provided to SQI Estimator 480. Pre-Defined User Input 456 is forwarded to the SQI Estimator 480 from the domain expert regarding the Service-Wise KPI Importance 453 and KPI Performance Thresholds 454.

SQI Estimator applies Machine Learning to produce Network Level SQI Estimates using the Network Level KPIs and the Generalized User Level CEI Estimates based on the Service-Wise KPI Importance and KPI Performance Thresholds S538. Referring to FIG. 4, SQI Estimator 480 applies Machine Learning to the Network Level KPIs 472 and the User Level CEI Estimates 460 to produce Network Level SQI Estimates 490 at Output 482 of SQI Estimator 480. SQI Estimator 480 produces Network Level SQI Estimates 490 that include Network KPI Weight Distribution and aggregation of User Level CEI Estimates 460 and/or Network Level KPIs 472 per service. Again, Pre-Defined User Input 456 is forwarded to the SQI Estimator 480 from the domain expert regarding the Service-Wise KPI Importance 453 and KPI Performance Thresholds 454. SQI Estimator 480 calculates or estimates Network Level SQI Estimates 490 in two ways. First, SQI Estimator 480 uses the Data Input 462 of User Level CEI Estimates 460 from the CEI Estimator 460 and applies Machine Learning to estimate the Network Level SQI Estimates 490. Alternatively, SQI Estimator 480 uses the User Level KPIs aggregated at the network level to produce the Network Level KPIs 472 and applies Machine Learning to calculate Network SQI Estimates 490.

The process then terminates S550.

At least one embodiment of the method includes obtaining Call Direct Record (CDR) Data from Probing Devices of a mobile network. The CDR Data is processed at a Key Performance Indicators (KPI) Generator to generate User Level KPIs. The User Level KPIs are provided to a Customer Experience Index (CEI) Estimator. Machine Learning is applied to the User Level KPIs at the CEI Estimator to generate Generalized User Level CEI Estimates. The Generalized User Level CEI Estimates are provided to a Service Quality Index (SQI) Estimator. Machine Learning is applied to the Generalized User Level CEI Estimates at the SQI Estimator to generate Network Level SQI Estimates.

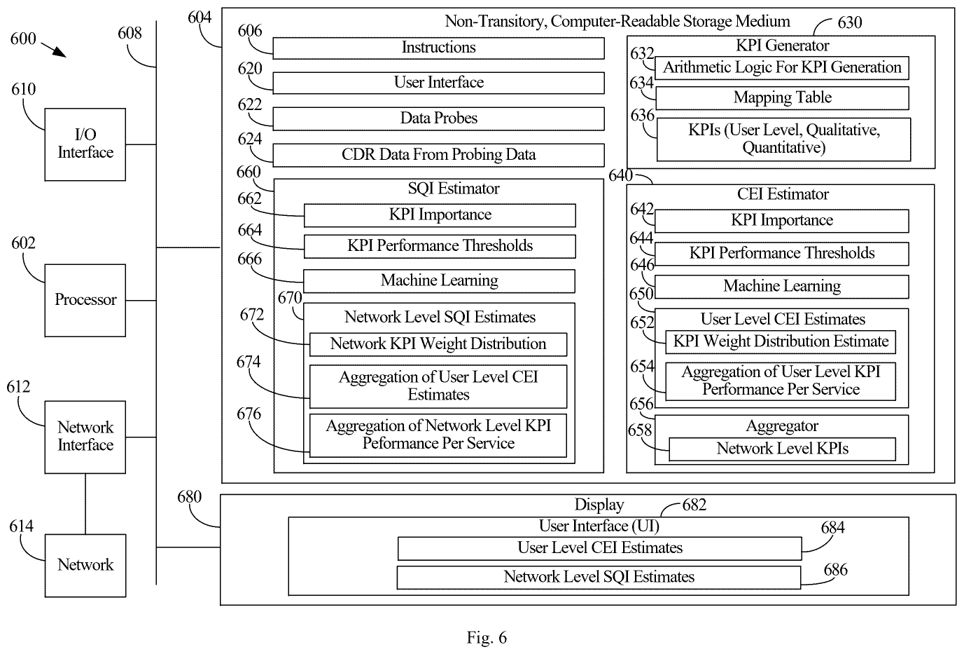

FIG. 6 is a high-level functional block diagram of a processor-based system 600 according to at least one embodiment.

In at least one embodiment, processing circuitry 600 provides a Smart Service Analyzer. Processing circuitry 600 implements a Smart Service Analyzer using Processor 602. Processing circuitry 600 also includes a Non-Transitory, Computer-Readable Storage Medium 604 that is used to implement a Smart Service Analyzer. Non-Transitory, Computer-Readable Storage Medium 604, amongst other things, is encoded with, i.e., stores, Instructions 606, i.e., computer program code, that are executed by Processor 602 causes Processor 602 to perform operations for providing a Smart Service Analyzer. Execution of Instructions 606 by Processor 602 represents (at least in part) an application which implements at least a portion of the methods described herein in accordance with one or more embodiments (hereinafter, the noted processes and/or methods).

Processor 602 is electrically coupled to Non-Transitory, Computer-Readable Storage Medium 604 via a Bus 608. Processor 602 is electrically coupled to an Input/Output (I/O) Interface 610 by Bus 608. A Network Interface 612 is also electrically connected to Processor 602 via Bus 608. Network Interface 612 is connected to a Network 614, so that Processor 602 and Non-Transitory, Computer-Readable Storage Medium 604 connect to external elements via Network 614. Processor 602 is configured to execute Instructions 606 encoded in Non-Transitory, Computer-Readable Storage Medium 604 to cause processing circuitry 600 to be usable for performing at least a portion of the processes and/or methods. In one or more embodiments, Processor 602 is a Central Processing Unit (CPU), a multi-processor, a distributed processing system, an Application Specific Integrated Circuit (ASIC), and/or a suitable processing unit.

Processing circuitry 600 includes I/O Interface 610. I/O interface 610 is coupled to external circuitry. In one or more embodiments, I/O Interface 610 includes a keyboard, keypad, mouse, trackball, trackpad, touchscreen, and/or cursor direction keys for communicating information and commands to Processor 602.

Processing circuitry 600 also includes Network Interface 612 coupled to Processor 602. Network Interface 612 allows processing circuitry 600 to communicate with Network 614, to which one or more other computer systems are connected. Network Interface 612 includes wireless network interfaces such as Bluetooth, Wi-Fi, Worldwide Interoperability for Microwave Access (WiMAX), General Packet Radio Service (GPRS), or Wideband Code Division Multiple Access (WCDMA); or wired network interfaces such as Ethernet, Universal Serial Bus (USB), or Institute of Electrical and Electronics Engineers (IEEE) 864.

Processing circuitry 600 is configured to receive information through I/O Interface 610. The information received through I/O Interface 610 includes one or more of instructions, data, design rules, libraries of cells, and/or other parameters for processing by Processor 602. The information is transferred to Processor 602 via Bus 608. Processing circuitry 600 is configured to receive information related to a User Interface (UI) through I/O Interface 610. The information is stored in Non-Transitory, Computer-Readable Storage Medium 604 as UI 620.

In one or more embodiments, one or more Non-Transitory, Computer-Readable Storage Medium 604 having stored thereon Instructions 606 (in compressed or uncompressed form) that may be used to program a computer, processor, or other electronic device) to perform processes or methods described herein. The one or more Non-Transitory, Computer-Readable Storage Medium 604 includes one or more of an electronic storage medium, a magnetic storage medium, an optical storage medium, a quantum storage medium, or the like.

For example, the Non-Transitory, Computer-Readable Storage Medium 604 may include, but are not limited to, hard drives, floppy diskettes, optical disks, read-only memories (ROMs), random access memories (RAMs), erasable programmable ROMs (EPROMs), electrically erasable programmable ROMs (EEPROMs), flash memory, magnetic or optical cards, solid-state memory devices, or other types of physical media suitable for storing electronic instructions. In one or more embodiments using optical disks, the one or more Non-Transitory Computer-Readable Storage Media 604 includes a Compact Disk-Read Only Memory (CD-ROM), a Compact Disk-Read/Write (CD-R/W), and/or a Digital Video Disc (DVD).

In one or more embodiments, Non-Transitory, Computer-Readable Storage Medium 604 stores Instructions 606 configured to cause Processor 602 to perform at least a portion of the processes and/or methods for providing a Smart Service Analyzer. In one or more embodiments, Non-Transitory, Computer-Readable Storage Medium 604 also stores information, such as algorithm which facilitates performing at least a portion of the processes and/or methods for providing a Smart Service Analyzer.

Accordingly, in at least one embodiment, Processor 602 executes Instructions 606 stored on the one or more Non-Transitory, Computer-Readable Storage Medium 604 to implement a Smart Service Analyzer. Processor 602 implements Data Probes 622 to obtain CDR Data 624 using Data Probes 622. Processor 602 implements a KPI Generator 630 and provides CDR Probing Data 624 obtained from Data Probes to the KPI Generator 630. Processor 602 provides arithmetic logic-based Aggregation Formula 632 for KPIs to the KPI Generator 630, where the KPI Generator 630 uses the arithmetic logic-based Aggregation Formula 632 to generate User Level KPIs 636 from the CDR Data 624. Processor 602 also provides Mapping Table 634 from network engineers to the KPI Generator 630 to map KPIs to columns in tables of the CDR Data 624. Processor 602 causes KPI Generator 630 to apply the arithmetic logic-based Aggregation Formula 632 to generate User Level KPIs 636 based on the Mapping Table 634. Processor 602 implements a Customer Experience Index (CEI) Estimator 640. Processor 602 provides Service-wise KPI Importance 642, such as Critical, High, Medium, and Low Indicators, and KPI Performance Thresholds 644 for Qualitative KPIs to CEI Estimator 640. Processor 602 dynamically updates Quantitative KPI Performance Thresholds 644 by analyzing trend deviations.

Processor 602 implements Machine Learning 646 in CEI Estimator 640. Processor 602 causes CEI Estimator 640 to apply Machine Learning 646 to produce User Level CEI Estimates 650 at the service level based on the User Level KPIs 636. Processor 602 causes CEI Estimator 640 to apply Machine Learning 646 to produce User Level CEI Estimates 650 that includes a KPI Weight Distribution Estimate 652 for the services and Aggregation of User Level KPI Performance Per Service 654 at the user level. Processor 602 causes CEI Estimator 640 to generalize User Level CEI Estimates 650. Generalizing User Level CEI Estimates results in no change or modification in response to a KPI being added or removed from a particular service. Previously, different types of predefined rule-based algorithms were changed in response to a KPI being removed from some service or added to a service. KPI trend shift events are able to be detected and alarms are automatically emailed to stakeholders. Processor 602 also provides the User Level KPIs to an Aggregator 656 for aggregation to produce Network Level KPIs 658. Processor 602 implements a Service Quality Index (SQI) Estimator 660. Processor 602 provides the Network Level KPIs 658, along with the User Level CEI Estimates 650, KPI Importance 662, and KPI Performance Thresholds 664 as input to SQI Estimator 660. Processor 602 implements Machine Learning 666 at SQI Estimator 660 to produce Network Level SQI Estimates 670. Processor 602 causes SQI Estimator 660 to produce Network Level SQI Estimates 670 that include Network KPI Weight Distribution 672 and aggregation of User Level CEI Estimates 674 and/or Aggregation of Network Level KPIs Per Service 676. Processor 602 causes SQI Estimator 660 to apply Machine Learning 666 using the Service-Wise KPI Importance 662 and KPI Performance Thresholds 664. Processor 602 causes SQI Estimator 660 to calculate or estimate Network Level SQI Estimates 670 in two ways. First, Processor 602 causes SQI Estimator 660 to use the User Level CEI Estimates 650 output from the CEI Estimator 640 and apply Machine Learning 666 to estimate the Network Level SQI Estimates 670. Alternatively, Processor 602 causes SQI Estimator 660 to use the Network Level KPIs 658, and applies Machine Learning 666 to calculate Network Level SQI Estimates 670. Processor 602 implements User Interface (UI) 682 on Display 680. Processor 602 presents User Level CEI Estimates 684 and Network Level SQI Estimates 686 on UI 682 of Display 680.

Embodiments described herein provide method that provides one or more advantages. For example, the Smart Service Analyzer provided an end-to-end automated solution. The Smart Service Analyzer is able to be used as a tool by network engineers to estimate the impact of different services at the user level and at the network level without updating logic and while adding or deleting KPIs from a service. The Smart Service Analyzer notifies stakeholders via automatic email systems while any significant deviation or change is detected in quantitative KPI trends.

[1] An aspect of this description is directed to a method that includes obtaining Call Direct Record (CDR) Data from Probing Devices of a mobile network, processing the CDR Data at a Key Performance Indicators (KPI) Generator to generate User Level KPIs, providing the User Level KPIs to a Customer Experience Index (CEI) Estimator, applying Machine Learning to the User Level KPIs at the CEI Estimator to generate Generalized User Level CEI Estimates, providing the Generalized User Level CEI Estimates to a Service Quality Index (SQI) Estimator, and applying Machine Learning to the Generalized User Level CEI Estimates at the SQI Estimator to generate Network Level SQI Estimates.

[2] The method described in [1], wherein the processing the CDR Data to generate the User Level KPIs further includes receiving receives Arithmetic Logic-Based Aggregation Formula for KPIs and a Mapping Table to map KPIs to columns in tables of the CDR Data, and applying arithmetic operations to columns of the CDR Probing Data based on the Arithmetic Logic-Based Aggregation Formula and the Mapping Table to generate the User Level KPIs.

[3] The method described in any of [1] to [2], wherein the applying the Machine Learning to the User Level KPIs at the CEI Estimator to generate the Generalized User Level CEI Estimates further includes receiving Service-Wise KPI Importance, receiving KPI Performance Thresholds, and applying the Machine Learning to generate Generalized User Level CEI Estimates at a service level based on the User Level KPIs, the Service-Wise KPI Importance, and the KPI Performance Thresholds.

[4] The method described in any of [1] to [3], wherein the receiving the Service-Wise KPI Importance includes receiving Service-Wise KPI Importance having Critical, High, Medium, and Low Indicators, and wherein the receiving the KPI Performance Thresholds includes receiving the KPI Performance Thresholds for Qualitative KPIs and Quantitative KPIs, wherein the KPI Performance Thresholds for Quantitative KPIs are dynamically updated based on determined trend shifts.

[5] The method described in any of [1] to [4], wherein the applying the Machine Learning to the Generalized User Level CEI Estimates at the SQI Estimator to generate the Network Level SQI Estimates further includes providing the User Level KPIs to an Aggregator for aggregation to produce Network Level KPIs, receiving the Network Level KPIs, the Generalized User Level CEI

Estimates, Service-Wise KPI Importance, and KPI Performance Thresholds at the Service Quality Index (SQI) Estimator, and applying the Machine Learning to produce the Network Level SQI Estimates using the Network Level KPIs and the Generalized User Level CEI Estimates based on the Service-Wise KPI Importance and the KPI Performance Thresholds.

[6] The method described in any of [1] to [5], wherein the obtaining the CDR Data from the Probing Devices includes obtaining the CDR Data at a predetermined granularity and for predetermined categories.

[7] The method described in any of [1] to [6], wherein the applying the Machine Learning to the Generalized User Level CEI Estimates at the SQI Estimator to generate the Network Level SQI Estimates includes generating Network Level SQI Estimates that include Network KPI Weight Distribution and aggregation of User Level CEI Estimates and/or Network Level KPIs per service.

[8] An aspect of this description is directed to a Smart Service Analyzer configured to obtain Call Direct Record (CDR) Data from Probing Devices of a mobile network, process the CDR Data at a Key Performance Indicators (KPI) Generator to generate User Level KPIs, provide the User Level KPIs to a Customer Experience Index (CEI) Estimator, apply Machine Learning to the User Level KPIs at the CEI Estimator to generate Generalized User Level CEI Estimates, provide the Generalized User Level CEI Estimates to a Service Quality Index (SQI) Estimator, and apply Machine Learning to the Generalized User Level CEI Estimates at the SQI Estimator to generate Network Level SQI Estimates.

[9] The Smart Service Analyzer described in [8], further configured to process the CDR Data to generate the User Level KPIs by receiving receives Arithmetic Logic-Based Aggregation Formula for KPIs and a Mapping Table to map KPIs to columns in tables of the CDR Data, and applying arithmetic operations to columns of the CDR Data based on the Arithmetic Logic-Based Aggregation Formula and the Mapping Table to generate the User Level KPIs.

The Smart Service Analyzer described in any of [8] to [9], further configured to apply the Machine Learning to the User Level KPIs at the CEI Estimator to generate the Generalized User Level CEI Estimates by receiving Service-Wise KPI Importance, receiving KPI Performance Thresholds, and applying the Machine Learning to generate Generalized User Level CEI Estimates at a service level based on the User Level KPIs, the Service-Wise KPI Importance, and the KPI Performance Thresholds.

The Smart Service Analyzer described in [8] to [10], further configured to receive the Service-Wise KPI Importance by receiving Service-Wise KPI Importance having Critical, High, Medium, and Low Indicators, and wherein the receiving the KPI Performance Thresholds includes receiving the KPI Performance Thresholds for Qualitative KPIs and Quantitative KPIs, wherein the KPI Performance Thresholds for the Qualitative KPIs are dynamically updated based on determined trend shifts.

The Smart Service Analyzer described in any of [8] to [11], further configured to apply the Machine Learning to the Generalized User Level CEI Estimates at the SQI Estimator to generate the Network Level SQI Estimates by providing the User Level KPIs to an Aggregator for aggregation to produce Network Level KPIs, receiving the Network Level KPIs, the Generalized User Level CEI Estimates, Service-Wise KPI Importance, and KPI Performance Thresholds at the Service Quality Index (SQI) Estimator, and applying the Machine Learning to produce the Network Level SQI Estimates using the Network Level KPIs and the Generalized User Level CEI Estimates based on the Service-Wise KPI Importance and KPI Performance Thresholds.

The Smart Service Analyzer described in any of [8] to [12], further configured to obtain the CDR Data from the Probing Devices by obtaining the CDR Data at a predetermined granularity and for predetermined categories.

The Smart Service Analyzer described in any of [8] to [13], further configured to apply the Machine Learning to the Generalized User Level CEI Estimates at the SQI Estimator to generate the Network Level SQI Estimates by generating Network Level SQI Estimates that include Network KPI Weight Distribution and aggregation of User Level CEI Estimates and/or Network Level KPIs per service.

An aspect of this description is directed to a non-transitory computer-readable media having computer-readable instructions stored thereon, which when executed perform operations including obtaining Call Direct Record (CDR) Data from Probing Devices of a mobile network, processing the CDR Data at a Key Performance Indicators (KPI) Generator to generate User Level KPIs, providing the User Level KPIs to a Customer Experience Index (CEI) Estimator, applying Machine Learning to the User Level KPIs at the CEI Estimator to generate Generalized User Level CEI Estimates, providing the Generalized User Level CEI Estimates to a Service Quality Index (SQI) Estimator, and applying Machine Learning to the Generalized User Level CEI Estimates at the SQI Estimator to generate Network Level SQI Estimates.

The non-transitory computer-readable media described in [15], wherein the processing the CDR Data to generate the User Level KPIs further includes receiving receives Arithmetic Logic-Based Aggregation Formula for KPIs and a Mapping Table to map KPIs to columns in tables of the CDR Data, and applying arithmetic operations to columns of the CDR Data based on the Arithmetic Logic-Based Aggregation Formula and the Mapping Table to generate the User Level KPIs.

The non-transitory computer-readable media described in any of to [16], wherein the applying the Machine Learning to the User Level KPIs at the CEI Estimator to generate the Generalized User Level CEI Estimates further includes receiving Service-Wise KPI Importance, receiving KPI Performance Thresholds, and applying the Machine Learning to generate Generalized User Level CEI Estimates at a service level based on the User Level KPIs, the Service-Wise KPI Importance, and the KPI Performance Thresholds, and wherein the receiving the Service-Wise KPI Importance includes receiving Service-Wise KPI Importance having Critical, High, Medium, and Low Indicators, and the receiving the KPI Performance Thresholds includes receiving the KPI Performance Thresholds for Qualitative KPIs and Quantitative KPIs, wherein the KPI Performance Thresholds for the Qualitative KPIs are dynamically updated based on determined trend shifts.

[18 The non-transitory computer-readable media described in any of to [17], wherein the applying the Machine Learning to the Generalized User Level CEI Estimates at the SQI Estimator to generate the Network Level SQI Estimates further includes providing the User Level KPIs to an Aggregator for aggregation to produce Network Level KPIs, receiving the Network Level KPIs, the Generalized User Level CEI Estimates, Service-Wise KPI Importance, and KPI Performance Thresholds at the Service Quality Index (SQI) Estimator, and applying the Machine Learning to produce the Network Level SQI Estimates using the Network Level KPIs and the Generalized User Level CEI Estimates based on the Service-Wise KPI Importance and KPI Performance Thresholds.

The non-transitory computer-readable media described in any of to [18], wherein the obtaining the CDR Data from the Probing Devices includes obtaining the CDR Data at a predetermined granularity and for predetermined categories.

The non-transitory computer-readable media described in any of to [19], wherein the applying the Machine Learning to the Generalized User Level CEI Estimates at the SQI

Estimator to generate the Network Level SQI Estimates includes generating Network Level SQI Estimates that include Network KPI Weight Distribution and aggregation of User Level CEI Estimates and/or Network Level KPIs per service.

Separate instances of these programs can be executed on or distributed across any number of separate computer systems. Thus, although certain steps have been described as being performed by certain devices, software programs, processes, or entities, this need not be the case. A variety of alternative implementations will be understood by those having ordinary skill in the art.

Additionally, those having ordinary skill in the art readily recognize that the techniques described above can be utilized in a variety of devices, environments, and situations. Although the embodiments have been described in language specific to structural features or methodological acts, the subject matter defined in the appended claims is not necessarily limited to the specific features or acts described. Rather, the specific features and acts are disclosed as exemplary forms of implementing the claims.

What is claimed is:

1. A method, comprising:
obtaining Call Direct Record (CDR) Data from Probing Devices of a mobile network;
processing the CDR Data at a Key Performance Indicators (KPI) Generator to generate User Level KPIs;
providing the User Level KPIs to a Customer Experience Index (CEI) Estimator;
applying Machine Learning to the User Level KPIs at the CEI Estimator to generate Generalized User Level CEI Estimates;
providing the Generalized User Level CEI Estimates to a Service Quality Index (SQI) Estimator; and
applying Machine Learning to the Generalized User Level CEI Estimates at the SQI Estimator to generate Network Level SQI Estimates.

2. The method of claim 1, wherein the processing the CDR Data to generate the User Level KPIs further includes:
receiving receives Arithmetic Logic-Based Aggregation Formula for KPIs and a Mapping Table to map KPIs to columns in tables of the CDR Data; and
applying arithmetic operations to columns of the CDR Probing Data based on the Arithmetic Logic-Based Aggregation Formula and the Mapping Table to generate the User Level KPIs.

3. The method of claim 1, wherein the applying the Machine Learning to the User Level KPIs at the CEI Estimator to generate the Generalized User Level CEI Estimates further includes:
receiving Service-Wise KPI Importance;
receiving KPI Performance Thresholds; and
applying the Machine Learning to generate Generalized User Level CEI Estimates at a service level based on the User Level KPIs, the Service-Wise KPI Importance, and the KPI Performance Thresholds.

4. The method of claim 3, wherein the receiving the Service-Wise KPI Importance includes receiving Service-Wise KPI Importance having Critical, High, Medium, and Low Indicators, and wherein the receiving the KPI Performance Thresholds includes receiving the KPI Performance Thresholds for Qualitative KPIs and Quantitative KPIs, wherein the KPI Performance Thresholds for the Quantitative KPIs are dynamically updated based on determined trend shifts.

5. The method of claim 1, wherein the applying the Machine Learning to the Generalized User Level CEI Estimates at the SQI Estimator to generate the Network Level SQI Estimates further includes:
providing the User Level KPIs to an Aggregator for aggregation to produce Network Level KPIs;
receiving the Network Level KPIs, the Generalized User Level CEI Estimates, Service-Wise KPI Importance, and KPI Performance Thresholds at the Service Quality Index (SQI) Estimator; and
applying the Machine Learning to produce the Network Level SQI Estimates using the Network Level KPIs and the Generalized User Level CEI Estimates based on the Service-Wise KPI Importance and the KPI Performance Thresholds.

6. The method of claim 1, wherein the obtaining the CDR Data from the Probing Devices includes obtaining the CDR Data at a predetermined granularity and for predetermined categories.

7. The method of claim 1, wherein the applying the Machine Learning to the Generalized User Level CEI Estimates at the SQI Estimator to generate the Network Level SQI Estimates includes generating Network Level SQI Estimates that include Network KPI Weight Distribution and aggregation of User Level CEI Estimates and/or Network Level KPIs per service.

8. A Smart Service Analyzer configured to perform operations to:
obtain Call Direct Record (CDR) Data from Probing Devices of a mobile network;
process the CDR Data at a Key Performance Indicators (KPI) Generator to generate User Level KPIs;
provide the User Level KPIs to a Customer Experience Index (CEI) Estimator;
apply Machine Learning to the User Level KPIs at the CEI Estimator to generate Generalized User Level CEI Estimates;
provide the Generalized User Level CEI Estimates to a Service Quality Index (SQI) Estimator; and
apply Machine Learning to the Generalized User Level CEI Estimates at the SQI Estimator to generate Network Level SQI Estimates.

9. The Smart Service Analyzer of claim 8, further configured to process the CDR Data to generate the User Level KPIs by receiving receives Arithmetic Logic-Based Aggregation Formula for KPIs and a Mapping Table to map KPIs to columns in tables of the CDR Data, and applying arithmetic operations to columns of the CDR Data based on the Arithmetic Logic-Based Aggregation Formula and the Mapping Table to generate the User Level KPIs.

10. The Smart Service Analyzer of claim 8, further configured to apply the Machine Learning to the User Level KPIs at the CEI Estimator to generate the Generalized User Level CEI Estimates by:
receiving Service-Wise KPI Importance;
receiving KPI Performance Thresholds; and
applying the Machine Learning to generate Generalized User Level CEI Estimates at a service level based on the User Level KPIs, the Service-Wise KPI Importance, and the KPI Performance Thresholds.

11. The Smart Service Analyzer of claim 10, further configured to receive the Service-Wise KPI Importance by receiving Service-Wise KPI Importance having Critical, High, Medium, and Low Indicators, and wherein the receiving the KPI Performance Thresholds includes receiving the KPI Performance Thresholds for Qualitative KPIs and Quantitative KPIs, wherein the KPI Performance Thresholds for the Quantitative KPIs are dynamically updated based on determined trend shifts.

12. The Smart Service Analyzer of claim 8, further configured to apply the Machine Learning to the Generalized User Level CEI Estimates at the SQI Estimator to generate the Network Level SQI Estimates by:
providing the User Level KPIs to an Aggregator for aggregation to produce Network Level KPIs;
receiving the Network Level KPIs, the Generalized User Level CEI Estimates, Service-Wise KPI Importance, and KPI Performance Thresholds at the Service Quality Index (SQI) Estimator; and
applying the Machine Learning to produce the Network Level SQI Estimates using the Network Level KPIs and the Generalized User Level CEI Estimates based on the Service-Wise KPI Importance and KPI Performance Thresholds.

13. The Smart Service Analyzer of claim 8, further configured to obtain the CDR Data from the Probing Devices by obtaining the CDR Data at a predetermined granularity and for predetermined categories.

14. The Smart Service Analyzer of claim 8, further configured to apply the Machine Learning to the Generalized User Level CEI Estimates at the SQI Estimator to generate the Network Level SQI Estimates by generating Network Level SQI Estimates that include Network KPI Weight Distribution and aggregation of User Level CEI Estimates and/or Network Level KPIs per service.

15. A non-transitory computer-readable media having computer-readable instructions stored thereon, which when executed perform operations comprising:
obtaining Call Direct Record (CDR) Data from Probing Devices of a mobile network;
processing the CDR Data at a Key Performance Indicators (KPI) Generator to generate User Level KPIs;
providing the User Level KPIs to a Customer Experience Index (CEI) Estimator;
applying Machine Learning to the User Level KPIs at the CEI Estimator to generate Generalized User Level CEI Estimates;
providing the Generalized User Level CEI Estimates to a Service Quality Index (SQI) Estimator; and
applying Machine Learning to the Generalized User Level CEI Estimates at the SQI Estimator to generate Network Level SQI Estimates.

16. The non-transitory computer-readable media of claim 15, wherein the processing the CDR Data to generate the User Level KPIs further includes:
receiving receives Arithmetic Logic-Based Aggregation Formula for KPIs and a Mapping Table to map KPIs to columns in tables of the CDR Data; and
applying arithmetic operations to columns of the CDR Data based on the Arithmetic Logic-Based Aggregation Formula and the Mapping Table to generate the User Level KPIs.

17. The non-transitory computer-readable media of claim 15, wherein:
the applying the Machine Learning to the User Level KPIs at the CEI Estimator to generate the Generalized User Level CEI Estimates further includes receiving Service-Wise KPI Importance, receiving KPI Performance Thresholds, and applying the Machine Learning to generate Generalized User Level CEI Estimates at a service level based on the User Level KPIs, the Service-Wise KPI Importance, and the KPI Performance Thresholds; and
the receiving the Service-Wise KPI Importance includes receiving Service-Wise KPI Importance having Critical, High, Medium, and Low Indicators, and the receiving the KPI Performance Thresholds includes receiving the KPI Performance Thresholds for Qualitative KPIs and Quantitative KPIs, wherein the KPI Performance Thresholds for the Quantitative KPIs are dynamically updated based on determined trend shifts.

18. The non-transitory computer-readable media of claim 15, wherein the applying the Machine Learning to the Generalized User Level CEI Estimates at the SQI Estimator to generate the Network Level SQI Estimates further includes:
providing the User Level KPIs to an Aggregator for aggregation to produce Network Level KPIs;
receiving the Network Level KPIs, the Generalized User Level CEI Estimates, Service-Wise KPI Importance, and KPI Performance Thresholds at the Service Quality Index (SQI) Estimator; and
applying the Machine Learning to produce the Network Level SQI Estimates using the Network Level KPIs and the Generalized User Level CEI Estimates based on the Service-Wise KPI Importance and KPI Performance Thresholds.

19. The non-transitory computer-readable media of claim 15, wherein the obtaining the CDR Data from the Probing Devices includes obtaining the CDR Data at a predetermined granularity and for predetermined categories.

20. The non-transitory computer-readable media of claim 15, wherein the applying the Machine Learning to the Generalized User Level CEI Estimates at the SQI Estimator to generate the Network Level SQI Estimates includes generating Network Level SQI Estimates that include Network KPI Weight Distribution and aggregation of User Level CEI Estimates and/or Network Level KPIs per service.
